(19) United States
(12) Patent Application Publication
(10) Pub. No.: US 2014/0184953 A1
(43) Pub. Date: Jul. 3, 2014

(54) TOUCH PANEL

(71) Applicant: SAMSUNG ELECTRO-MECHANICS CO., LTD., Suwon-si (KR)

(72) Inventors: Jung Eun Noh, Suwon-si (KR); Seung Heon Han, Suwon-si (KR); Hee Soo Kim, Suwon-si (KR); Jung Tae Park, Suwon-si (KR); Sung Yeol Park, Suwon-si (KR)

(73) Assignee: SAMSUNG ELECTRO-MECHANICS CO., LTD., Suwon-si (KR)

(21) Appl. No.: 14/142,694

(22) Filed: Dec. 27, 2013

(30) Foreign Application Priority Data
Dec. 31, 2012 (KR) 10-2012-0158382

(51) Int. Cl. G06F 1/16

(52) U.S. Cl. CPC G06F 1/1692
USPC 349/12

(57) ABSTRACT

Disclosed herein is a touch panel including: a transparent substrate and an electrode pattern formed on one surface of the transparent substrate, wherein the transparent substrate has concave-convex portions formed on one surface thereof, and the electrode pattern is formed in a shape corresponding to those of the concave-convex portions on the concave-convex portions. According to the present invention, the concave-convex portions are formed on the transparent substrate to make heights of electrode patterns irregular, thereby making it possible to prevent a moiré phenomenon generated when a mesh pattern is used as the electrode pattern.

### CROSS REFERENCE TO RELATED APPLICATION

This application claims the benefit of Korean Patent Application No. 10-2012-0158382, filed on Dec. 31, 2012, entitled “Touch Panel,” which is hereby incorporated by reference in its entirety into this application.

### BACKGROUND OF THE INVENTION

1. Technical Field

The present invention relates to a touch panel.

2. Description of the Related Art

In accordance with the growth of computers using a digital technology, devices assisting computers have also been developed, and personal computers, portable transmitters and other personal information processors execute processing of text and graphics using a variety of input devices such as a keyboard and a mouse.

However, in accordance with rapid advancement of an information-oriented society, since use of computers has increasingly expanded, it is difficult to efficiently operate a product using only the keyboard and the mouse currently serving as the input device. Therefore, necessity for a device which is simple, has less malfunction, and is capable of easily inputting information has increased.

Furthermore, current techniques for input devices exceed the level of fulfilling general functions and thus are progressing towards high reliability, durability, innovation, designing and manufacturing related techniques, etc. To this end, a touch panel has been developed as an input device capable of inputting information such as text and graphics, etc.

This touch panel is mounted on a display surface of an image display device such as an electronic organizer, a flat panel display device including a liquid crystal display (LCD) device, a plasma display panel (PDP), an electroluminescence (El) element, or the like, or a cathode ray tube (CRT) to thereby allow a user to select desired information while viewing the image display device.

The touch panel is classified into a resistive type, a capacitive type, an electromagnetic type, a surface acoustic wave (SAW) type, and an infrared type. These various types of touch panels are adapted for electronic products in consideration of a signal amplification problem, a resolution difference, a degree of difficulty of designing and processing technology, optical properties, electrical properties, mechanical properties, resistance to the environment, input properties, durability, and economic benefits. In current, the capacitive type has been prevalently used in a broad range of fields.

Meanwhile, as disclosed in Japanese Patent Laid-Open publication No. 2011-248722 various methods have been proposed in order to reduce visibility of electrode patterns. Electrode patterns are less recognized by adjusting angles and forms for shapes of portions where electrode patterns are overlapped with each other, such that the entire visibility of a touch panel is improved. However, various problems have been generated in visibility of electrode patterns, such as a limitation in changing those shapes, generation of a moiré phenomenon according to a combination of regular shapes, and the like.

### PRIOR ART DOCUMENT

[Patent Document]

(Patent Document 1): JP 2011-248722 A

### SUMMARY OF THE INVENTION

The present invention has been made in an effort to provide a touch panel capable of having improved visibility by forming electrode patterns on a transparent substrate at irregular heights to reduce a recognition rate of the electrode patterns and reduce a moiré phenomenon that may be generated depending on shapes of the electrode patterns.

According to a preferred embodiment of the present invention, there is provided a touch panel including: a transparent substrate; and an electrode pattern formed on one surface of the transparent substrate, wherein the transparent substrate has concave-convex portions formed on one surface thereof; and the electrode pattern is formed in a shape corresponding to those of the concave-convex portions on the concave-convex portions.

The concave-convex portions may be formed by a combination of convex portions protruding from one surface of the transparent substrate and concave portions grooved inwardly from one surface of the transparent substrate, and convex portions adjacent to each other are formed at different heights in a protruding direction.

The concave-convex portions may be formed in one direction in which the electrode pattern is formed, and convex portions adjacent to each other in one direction in which the electrode pattern is formed have different heights.

The transparent substrate may be made of polyethylene terephthalate (PET), polycarbonate (PC), poly methyl methacrylate (PMMA), polyethylene naphthalate (PEN), polyethersulfone (PES), a cyclic olefin polymer (COC), a triacetylcellulose (TAC) film, a polyvinyl alcohol (PVA) film, a polyimide (PT) film, polystyrene (PS), biaxially oriented polystyrene (BOPS; containing K resin), glass or tempered glass.

The electrode pattern may be made of copper (Cu), aluminum (Al), gold (Au), silver (Ag), titanium (Ti), palladium (Pd), and chromium (Cr) or a combination thereof, or a silver salt emulsion layer.

The touch panel may further include a mold layer for planarizing an upper surface of the transparent on which the electrode pattern is formed.

The mold layer may be made of an epoxy or acrylic resin.

According to another preferred embodiment of the present invention, there is provided a touch panel including: a first transparent substrate having a first electrode pattern formed in one direction on one surface thereof; and a second transparent substrate having a second electrode pattern formed on one surface thereof so as to face the first electrode pattern and vertically intersect with one direction in which the first electrode pattern is formed, wherein the transparent substrate has concave-convex portions formed thereon, and the first electrode pattern is formed on the concave-convex portions so as to correspond to the concave-convex portions

The second transparent substrate may have concave-convex portions formed on one surface thereof; and the second electrode pattern may be formed on the concave-convex portions so as to correspond to the concave-convex portions.

The concave-convex portions may be formed by a combination of convex portions protruding from one surface of the transparent substrate and concave portions grooved inwardly from one surface of the transparent substrate, and convex portions adjacent to each other may be formed at different heights in a protruding direction.

The concave-convex portions may be formed in the direction in which the first electrode pattern or the second electrode pattern is formed, and convex portions formed in one direction in which the first electrode pattern is formed and adjacent to each other may have different heights.

The touch panel may further include a mold layer for planarizing an upper surface of the first transparent substrate or the second transparent substrate on which the first electrode pattern or the second electrode pattern is formed.

The mold layer may be made of an epoxy or acrylic resin.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view showing electrode patterns formed on a transparent substrate according to a preferred embodiment of the present invention;

FIG. 2 is a cross-sectional view taken along line A-A′ in FIG. 1;

FIG. 3 is a cross-sectional view of a touch panel according to another preferred embodiment of the present invention; and

FIG. 4 is a cross-sectional view of a touch panel according to still another preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

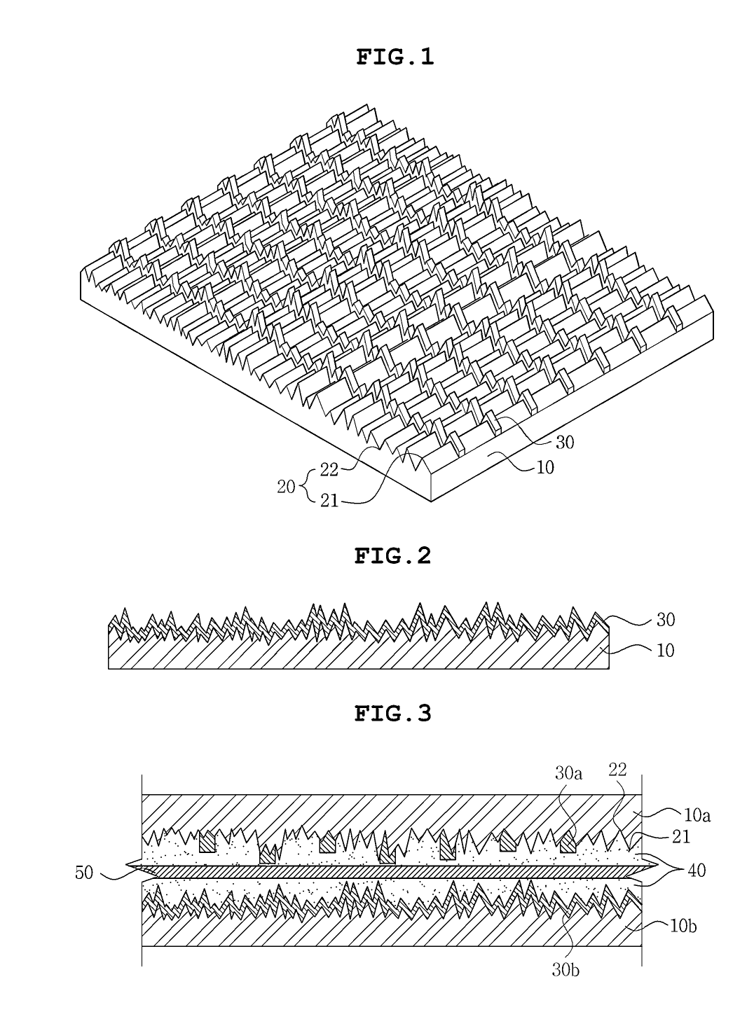

FIG. 1 is a perspective view of electrode patterns formed on a transparent substrate 10 according to a preferred embodiment of the present invention; and FIG. 2 is a cross-sectional view taken along line A-A′ in FIG. 1.

A touch panel according to the preferred embodiment of the present invention may include the transparent substrate 10 and the electrode patterns 30 formed on one surface of the transparent substrate 10, wherein the transparent substrate 10 has concave-convex portions 20 formed on one surface thereof; and the electrode patterns 30 is formed in shapes corresponding to those of the concave-convex portions 20 on the concave-convex portions 20.

The transparent substrate 10 serves to provide a region in which the electrode patterns 30 and electrode wiring are to be formed. Here, the transparent substrate 10 is divided into an active region in which the electrode patterns 30 are formed so as to sense a touch by an input device and a bezel region in which electrode wiring electrically connected to the electrode patterns 30 is formed. The active region is provided at the center of the transparent substrate 10 and the bezel region is provided at edges of the active region. In this case, the transparent substrate 10 needs to have support force capable of supporting the electrode patterns 30 and the electrode wiring and transparency capable of allowing a user to recognize an image provided by an image display device. To this end, the transparent substrate 10 may be made of, but is not necessarily limited thereto, polyethylene terephthalate (PET), polycarbonate (PC), poly methyl methacrylate (PMMA), polyethylene naphthalate (PEN), polyethersulfone (PES), a cyclic olefin polymer (COC), a triacetylcellulose (TAC) film, a polyvinyl alcohol (PVA) film, a polyimide (PI) film, polystyrene (PS), biaxially oriented polystyrene (BOPS; containing K resin), glass, tempered glass, or the like.

Meanwhile, the transparent substrate 10 may be a window provided at the outmost portion of the touch panel. If the transparent substrate 10 is the window as described above, since the electrode patterns 30 are formed directly on the window, a process of forming the electrode patterns 30 on a separate transparent substrate 10 and then attaching the transparent substrate 10 to the window is omitted, thereby making it possible to simplify a manufacturing process and reduce the entire thickness of the touch panel.

According to the present invention, concave-convex portions 20 are formed on the transparent substrate 10. It is preferable that the concave-convex portions 20 are formed in irregular patterns by roughening the surface of the transparent substrate 10. In particular, one surface of the transparent 10 on which the electrode patterns 30 are to be formed is formed in irregular concave-convex shapes, thereby making it possible to prevent a moiré phenomenon generated at the time of forming mesh patterns for the electrode patterns 30. The concave-convex portions 20 may be formed by a combination of concave portions 22 and convex portions 21, wherein the convex portions 21 may be formed at different heights in a protruding direction. This is because a moiré phenomenon due to regular mesh patterns may be recognized by a user if the convex portions 21 are formed at a uniform height. The convex portions 21 are formed at different heights or the concave portions 22 are formed at different depths, thereby making it possible to form the electrode patterns 30 at irregular heights on the concave-convex portions 20.

The electrode patterns 30 may be formed in mesh patterns by using copper (Cu), aluminum (Al), gold (Au), silver (Ag), titanium (Ti), palladium (Pd), chromium (Cr), or a combination thereof. Here, the electrode patterns 30 may be formed by a plating process or a depositing process using sputtering. When the electrode patterns 30 are made of copper (Cu), surfaces of the electrode patterns 30 may be black-oxide treated. Here, the black-oxide treatment is to precipitate Cu₂O or CuO by oxidizing surfaces of the electrode patterns 30, in which Cu₂O is referred to as a brown oxide because of its brown color and CuO is referred to as a black oxide because of its black color. As described above, the surfaces of the electrode patterns 30 are black-oxide treated to prevent light from being reflected, thereby making it possible to improve visibility of the touch panel.

Meanwhile, the electrode patterns 30 may be made of metal silver formed by exposing/developing a silver salt emulsion layer, metal oxide such as indium tin oxide (ITO), or conducting polymer such as PEDOT/PSS flexible and simply coated, in addition to the metals discussed above.

The electrode patterns 30 may be made of ITO, PEDOT/PSS, carbon nanotube (CNT), graphene, zinc oxide (ZnO) or Al-doped zinc oxide (AZO).

Although the electrode patterns 30 are formed in a rod shape in the accompanying drawings, the electrode patterns 30 are not limited to being formed in the rod shape, but may be formed in a diamond shape, a quadrangle shape, a triangular shape, a circular shape, or any other patterns known in the art.

The electrode patterns 30 may be formed by a dry process, a wet process, or a direct patterning process. Here, an example of the dry process includes sputtering, evaporation, or the like, an example of the wet etching process includes dip coating, spin coating, roll coating, spray coating, or the like, and an example of the direct patterning process includes screen printing, gravure printing, inkjet printing, or the like.

Mold layers 40 may be formed over the surface on which the electrode patterns 30 are formed at irregular heights on the concave-convex portions 20 of the transparent substrate 10 to planarize an outer surface. The mold layers 40 is formed over the electrode patterns 30, thereby making it possible to prevent damage to the electrode patterns 30 or degradation of electrical reliability caused by different heights of the electrode patterns 30. The mold layers 40 may be formed through printing, chemical vapor deposition (CVD), sputtering, or the like. Further, the mold layers 40 may be made of a material with transparency, such as an epoxy or acrylic resin, an SiOₓ thin film or an SiNₓ film.

A touch panel according to another preferred embodiment of the present invention may include a first transparent substrate 10a having first electrode patterns 30a formed in one direction on one surface thereof; and a second transparent substrate 10b having second patterns 30b formed on one surface thereof so as to face the first electrode patterns and vertically intersect with one direction in which the first electrode patterns 30a are formed, wherein the transparent substrate 10a has concave-convex portions 20 formed thereon, and the first electrode pattern 30a are formed on the concave-convex portions 20 so as to correspond to the concave-convex portions 20.

The first electrode patterns 30a are formed on the first transparent substrate 10a, and the second electrode patterns 30b facing the first electrode patterns 30a are formed on the second transparent substrate 10b. If the first electrode patterns 30a are formed in one direction, the second electrode patterns 30b are formed in a direction vertically intersecting with the direction in which the first electrode patterns 30a are formed. The first transparent substrate 10a and the second transparent substrate 10b may be bonded to each other so that the first electrode pattern 30a and the second electrode pattern 30b face each other. The first and second transparent substrates 10a and 10b may be adhered to each other by an adhesive layer 50 at the time of bonding therebetween. Here, the adhesive layer may be made of a transparent material, for example, an optical clear adhesive (OCA) so as not to hinder a user from recognizing an image output from an image display device.

When the first transparent substrate 10a is used as the outermost window substrate, an image display device may be provided under the second transparent substrate 10b. Here, the image display device (not shown) serves to output an image and includes a liquid crystal display (LCD) device, a plasma display panel (PDP), an electroluminescence (EL), a cathode ray tube (CRT), or the like.

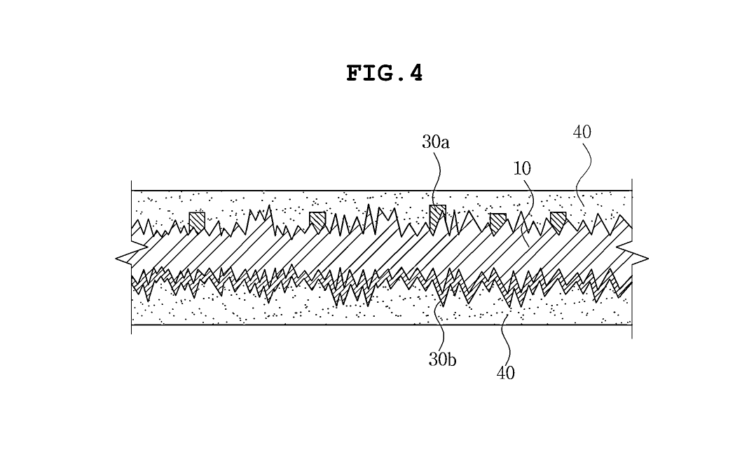

A touch panel according to still another preferred embodiment of the present invention includes concave-convex portions 20 formed on one surface and the other surface of a transparent substrate 10 and first electrode patterns 30a and second electrode patterns 30b formed on one surface and the other surface of the transparent substrate 10, respectively, such that it is implemented to have a thin thickness, as shown in FIG. 4. Each of the electrode patterns 30a, 30b may be provided with mold layers 40, as described above.

Since other components are identical to those of the preferred embodiment of the present invention discussed above, a description thereof will be omitted.

According to the preferred embodiments of the present invention, the concave-convex portions are formed on the transparent substrate to make heights of electrode patterns irregular, thereby making it possible to prevent a moiré phenomenon generated when a mesh pattern is used as the electrode pattern.

In addition, the concave-convex portions are formed on the surface of the transparent substrate on which the electrode patterns are formed such that the electrode patterns seated on the concave-convex portions also have concave-convex shapes to reduce recognition of the electrode patterns, thereby making it possible to improve visibility of a touch panel.

Further, the mold layers are further formed over the electrode patterns, thereby making it possible to more easily implement a touch panel, protect the electrode patterns formed at irregular heights, and ensure electrical reliability.

Furthermore, the mold layers are formed over the electrode patterns to improve reliability of the electrode patterns, thereby making it possible to operational performance and drive reliability of a touch panel including the electrode patterns.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch panel comprising:
a transparent substrate; and
an electrode pattern formed on one surface of the transparent substrate,
wherein the transparent substrate has concave-convex portions formed on one surface thereof; and the electrode pattern is formed in a shape corresponding to those of the concave-convex portions on the concave-convex portions.

2. The touch panel according to claim 1, wherein the concave-convex portions are formed by a combination of convex portions protruding from one surface of the transparent substrate and concave portions grooved inwardly from one surface of the transparent substrate, and convex portions adjacent to each other are formed at different heights in a protruding direction.

3. The touch panel according to claim 1, wherein the concave-convex portions are formed in one direction in which the electrode pattern is formed, and convex portions adjacent to each other in one direction in which the electrode pattern is formed have different heights.

4. The touch panel according to claim 1, wherein the transparent substrate is made of polyethylene terephthalate (PET), polycarbonate (PC), poly methyl methacrylate (PMMA), polyethylene naphthalate (PEN), polyethersulfone (PES), a cyclic olefin polymer (COC), a triacetylcellulose (TAC) film, a polyvinyl alcohol (PVA) film, a polyimide (PI) film, polystyrene (PS), biaxially oriented polystyrene (BOPS; containing K resin), glass or tempered glass.

5. The touch panel according to claim 1, wherein the electrode pattern is made of copper (Cu), aluminum (Al), gold (Au), silver (Ag), titanium (Ti), palladium (Pd), and chromium (Cr) or a combination thereof; or a silver salt emulsion layer.

6. The touch panel according to claim 1, further comprising a mold layer for planarizing an upper surface of the transparent substrate on which the electrode pattern is formed.

7. The touch panel according to claim 6, wherein the mold layer is made of an epoxy or acrylic resin.

8. A touch panel comprising:
a first transparent substrate having a first electrode pattern formed in one direction on one surface thereof; and
a second transparent substrate having a second electrode pattern formed on one surface thereof so as to face the first electrode pattern and vertically intersect with one direction in which the first electrode pattern is formed,
wherein the transparent substrate has concave-convex portions formed thereon, and the first electrode pattern is formed on the concave-convex portions so as to correspond to the concave-convex portions.

9. The touch panel according to claim 8, wherein the second transparent substrate has concave-convex portions formed on one surface thereof; and the second electrode pattern is formed on the concave-convex portions so as to correspond to the concave-convex portions.

10. The touch panel according to claim 8, wherein the concave-convex portions are formed by a combination of convex portions protruding from one surface of the transparent substrate and concave portions grooved inwardly from one surface of the transparent substrate, and convex portions adjacent to each other are formed at different heights in a protruding direction.

11. The touch panel according to claim 8, wherein the concave-convex portions are formed in the direction in which the first electrode pattern or the second electrode pattern is formed, and convex portions formed in one direction in which the first electrode pattern is formed and adjacent to each other have different heights.

12. The touch panel according to claim 8, further comprising a mold layer for planarizing an upper surface of the first transparent substrate or the second transparent substrate on which the first electrode pattern or the second electrode pattern is formed.

13. The touch panel according to claim 12, wherein the mold layer is made of an epoxy or acrylic resin.
